(19) United States
(12) Patent Application Publication
(10) Pub. No.: US 2001/0028705 A1
(43) Pub. Date: Oct. 11, 2001

(54) Prepaid direct dial long distance telecommunication services

(76) Inventors: Mark W. Adams, Washington, DC (US); Harry R. Miller, Branford, CT (US); Bernard R. Huelsman, Alexandria, VA (US); Michael T. Fallo, New York, NY (US); Muna Dalal, Hicksville, NY (US); Steven P. Walton, Alpharetta, GA (US); Fereydon Shenassa, Alpharetta, GA (US); Robert W. Livingston JR., Suwanee, GA (US); Patricia A. McVeigh, Gaithersburg, MD (US); Audrey A. Williams, Silver Spring, MD (US)

Correspondence Address: WOMBLE CARLYLE SANDRIDGE & RICE, P.O. Box 7037, Atlanta, GA, 30357-0037, US

(21) Appl. No.: 09/781,533

(22) Filed: Feb. 9, 2001

Related U.S. Application Data
(60) Provisional application No. 60/181,729, filed on Feb. 11, 2000.
(60) Provisional application No. 60/259,729, filed on Jan. 4, 2001.

(51) Int. Cl. H04M 15/00; H04M 17/00

(52) U.S. Cl. 379/114.2; 379/144.01

(57) ABSTRACT

Methods and apparatus for providing pre-paid long distance telephone calls without the requirement for dialing an access number or providing a personal identification number. Customers establish accounts with a service provider and keep the accounts replenished with finds. When the customer dials a long distance telephone number, the call is routed to a service provider's IVR platform, where a check is made for sufficient funds in the individual account. If there are sufficient funds, the call is completed, otherwise the customer is routed to a customer service representative and the customer can then replenish his account. The customer can replenish the account using different payment methods, such as at designated locations, the IVR, through the Internet, or with customer service representatives. Payments can be made by providing credit card or other financing information or by sending checks.

### CROSS-REFERENCE TO RELATED CASES

This application claims the benefit of U.S. Provision patent application No. 60/181,889, filed Feb. 11, 2000, and U.S. Provisional patent application No. 60/259,729, filed Jan. 4, 2001.

### TECHNICAL FIELD

This invention relates to telephony. More particularly, the present invention relates to delivery of telephone call services.

### SUMMARY OF THE INVENTION

Briefly described, the present invention comprises a system and method to provide long distance telephone call service to customers by way of a pre-paid system without the requirement of dialing an access number or personal identification code (PIN) before dialing the destination number.

In one embodiment, the pre-paid long distance (“PPLD”) system of the present invention comprises an integrated voice response (IVR) platform having voice response units, a host computer, and access to an account database, said system being connected to a telephone network. According to one method of the present invention, a long distance telephone call is routed to the IVR platform, the IVR platform checks the account database for availability of finds in an account (referred to herein interchangeably as the “account” or as the “pre-paid account”) associated with the telephone number placing the long distance call, and the IVR platform completes the call when there are sufficient funds in the account. The user sets up and funds the pre-paid account for his telephone with a service provider, and replenishes the account funding by using a credit card, debit/bank/check card, or other form of financing, electronic fund transfer, check or cash payment at designated locations or an automatic replenishment option. In a first embodiment, long distance calls made from the user's telephone are initiated without dialing any access number or providing any personal identification number (PIN). As used herein, the term “access number” refers to a number other than the common numeric long distance indicator, and dialing of an access number refers to the entry of such access number prior to the entry of a destination telephone number. The term “numeric long distance indicator,” as used herein refers to the numeric indicator common to all long distance accesses within a geographic region (for example, within the United States, the single digit “1” or internationally the combined digits “011”). In accordance with the present invention, customers dial the numeric long distance indicator (for example, the single digit “1” or the numeric phrase “011”) plus the “destination telephone number”, which refers herein to a telephone number (including any necessary area, country, city codes), and this dialing results in call completion and automatic payment from a pre-paid account. The call is routed to an IVR platform connected to a public switch telephone network (PSTN), where the IVR platform has access to a database having the pre-paid account information.

Customers may sign up for the pre-paid long distance telephone service in the same way that they establish long distance telephone service today. After signing up for the service, the primary interexchange carrier (PIC) code and/or local primary interexchange carrier (LPIC) of the customer's telephone line is changed to or assigned the carrier identification code (CIC) of the pre-paid long distance telephone service provider. The customer's telephone number may also be entered into the carrier's call routing database (e.g., for automatic number identification (“ANI”) purposes) for applications where the carrier's CIC supports the prepaid system as well as other long distance services. Accordingly, the long distance telephone service from the telephone line is then automatically routed to the pre-paid long distance service IVR platform of the present invention. In an alternate embodiment, the customer's calls are sent to the PPLD platform by Internet Protocol (IP) routing or through a wireless network using the mobile telephone number or electronic data signature of the terminal/phone. Reference herein to telephone networks and services should be understood to include or anticipate use of wireless or Internet or other communication networks.

The pre-paid service can also support cellular telephone service as part of a pre-paid telecommunications service bundle. The pre-paid account is established with cellular service by the sales channel. The cellular service can be established with its own balance in the account, or operate on the overall account balance. Cellular calls are routed by the cellular telephony network to the IVR platform. The call is rated by type (local, toll, roaming, etc.) and completed by the IVR platform.

In exemplary embodiments, a long distance call is initiated as a direct dial long distance call by customer (referred to herein interchangeably as user, end user or subscriber) dialing the numeric long distance indicator and an intended destination telephone number. The call is routed by standard carrier identification code (CIC) routing procedures (or, alternately, by automatic number identification (ANI) routing procedures), in a manner transparent to the customer. The switching facility serving the customer line performs network translations to route the call to the carrier switch. The carrier switch then sends the call on a dedicated trunk group to the pre-paid IVR platform. The IVR platform recognizes the customer line (e.g., the calling number) by the incoming automatic number identification (ANI). If the calling number is associated with a valid pre-paid account, the customer is notified, via an audio message played over the telephone line, of both his current account balance and the amount of time available for the specific call depending on the terminating location. The customer has the option to enable or disable the account balance message from the service menu, as well as other system generated audio messages such as the initial greeting message, the minutes remaining message, and the thank you for using message. Once the caller's account is verified, the call is then sent back to the carrier switch on a dedicated trunk group. From here, it is routed to the called number through the public telephone network. The call proceeds, and the account balance is reduced in periodic increments based on the cost of the specific call. In exemplary embodiments, the account balance is reduced in full-minute increments. The balance may, however, be reduced in partial-minute increments.

Before completing the call, the IVR platform performs an inquiry on this account to determine if there is sufficient funding available for completing the long distance call. If there is, the available balance is reported to the caller and the long distance call is completed, i.e., the destination telephone rings. However, if there is not enough funding, then a reporting message is played to the user, the telephone call will not be completed, and the caller is given the option to access the IVR platform voice response unit (VRU) to replenish the account or be routed to an operator who may assist in replenishing the account. After verifying funding for the telephone call, the system calculates available time based on the destination location and the prevailing calling rate to the destination. Likewise, a customer care agent will also be able to determine the calling rate to a destination, i.e., on-line rate quoting, via the PPLD software or system protocol.

After the telephone call is terminated, the account database is updated, i.e., the account properly adjusted for the cost of the telephone call. Upon terminating a call, the caller may remain on the line and the new account balance will be announced.

In an exemplary embodiment, warning messages about the remaining time will be given to the caller before the actual remaining time runs out. The caller has the option of terminating the call or reaching the VRU or an operator to replenish the account by dialing an access digit, before the call time expires. If the call time expires without the caller replenishing the account, the call is dropped. In some embodiments, the call is simply terminated when time expires, giving no option to replenish the account at the time of the call.

The replenishment of accounts is accomplished in several ways. In one embodiment of the present invention, accounts may be replenished by providing a credit card number (or other financing information) to a customer service representative or by the user establishing an automatic replenishment profile. Where the user establishes an automatic replenishment profile, the account can be replenished on a monthly basis or when the account depletes to a certain level. Accounts may also be replenished by paying at retail locations, via Internet, or via a service voice response unit (VRU). If the user wants to locate a retail location for payment, the user may access the IVR service menu and out-dial to the retail vendor's IVR platform to find the nearest location for payment. Accounts can further be replenished by mailing in checks, in which case the account balance will not reflect the replenishment until checks are cleared and actual payments are received. When replenishments are done by paying at retail locations, the payment information is transmitted to a server where the account database is located and accounts are updated accordingly. Upon replenishment, an ASCII message representing the remaining balance is returned to the retail establishment vendor allowing the vendor to print receipts for an end user indicating the purchased amount, and the ending balance on the account after the transaction. Accounts can further be replenished by mailing in checks to a customer service center, in which case the account balance will not reflect the replenishment until checks are cleared and actual payments are received.

In an alternate embodiment, when multiple persons have access to the same telephone line or otherwise at discretion of the user or provider, a caller must enter a PIN, at some point after dialing of the intended destination number, before the proper account information is accessed. Upon entering the PIN, the system identifies the account, checks the available balance, provides the balance information to the caller, and completes the call, if there are sufficient funds available.

### BRIEF DESCRIPTION OF DRAWINGS

The invention is better understood by reading the following detailed description in conjunction with the accompanying drawings, wherein:

FIG. 1 is a schematic diagram of a system architecture supporting the present invention, according to one embodiment.

FIG. 1A depicts the system architecture of FIG. 1, with examples of alternate storage device placement.

FIG. 2 is a schematic diagram of another system architecture according to an alternate embodiment of the present invention.

FIG. 2B is depicts the system architecture of FIG. 2, with alternate storage device placement.

FIGS. 3A and 3B are flow charts of pre-paid call processing, in accordance with an exemplary embodiment of the present invention.

FIG. 4 is a flow chart illustrating a method used in one embodiment of the invention for replenishment by direct payment.

FIG. 5 is a flow chart illustrating a method for replenishment via the Internet.

FIG. 6 is a flow chart illustrating a method for retail replenishment.

FIG. 7 is a flow chart illustrating a method for call in replenishment.

FIG. 8 is a flow chart illustrating a method for recurring replenishment.

### DETAILED DESCRIPTION

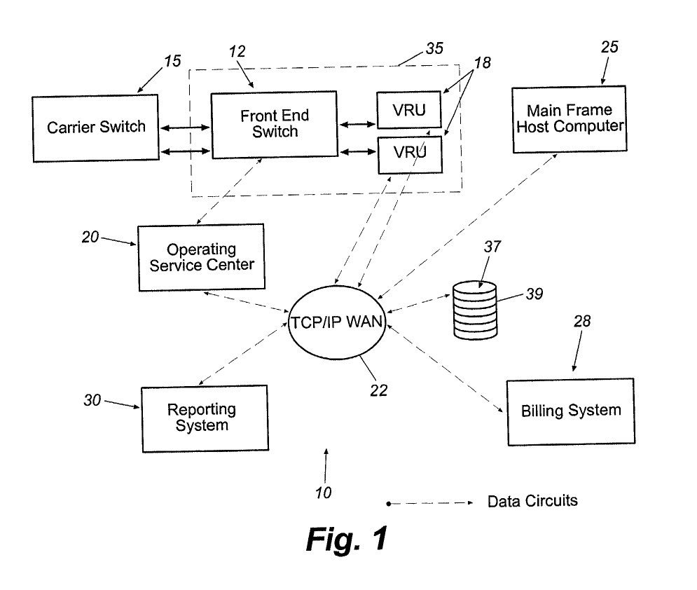

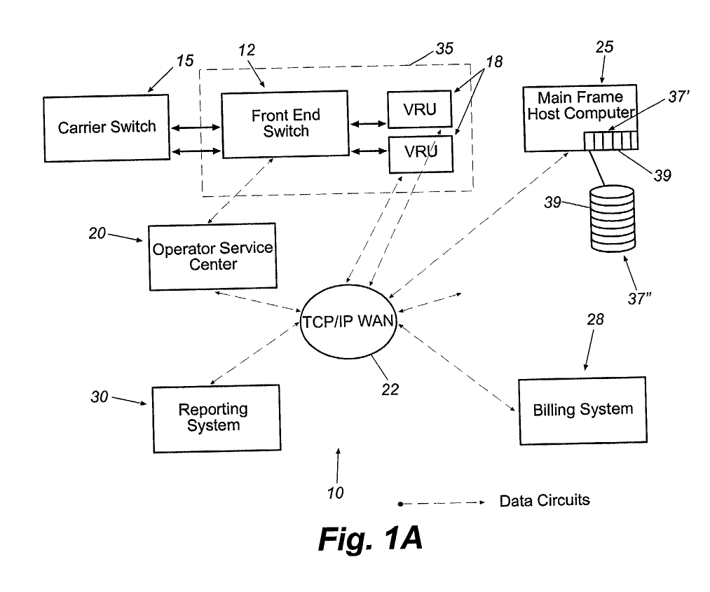

Referring now in more detail to the drawings in which like numerals refer to like components throughout the several views, FIG. 1 illustrates a schematic diagram of the system architecture of a prepaid long-distance (“PPLD”) System 10, according to one embodiment of the invention, that includes a front end switch 12, which is connected to a carrier switch 15 in a public switch telephone network (PSTN), a plurality of voice response units (VRU) 18, a customer service center(s) 20, and a memory storage device 37 for storing account records 39 connected to a TCP/IP based wide area data network (WAN) 22. (FIG. 1A depicts examples of alternate placements of the storage device 37′, 37″) Also connected to this TCP/IP WAN 22 are a host computer 25, a billing system 28 and a reporting system 30. The front-end switch 12 is fully redundant in the common controls and provides telephone network connectivity for all inbound and outbound calls. Command and control functions for the front-end switch 12 are provided by the host computer 25. The PPLD system embodiment of FIG. 1 depicts an IVR platform architecture in which the front-end switch 12 and VRUs 18 are located in local proximity to each other and are generally known as a voice response node 35, while the host computer 25 is depicted as being remote from the voice response node. As used herein, the term “in local proximity to” or “local” is intended to convey a sense of being within the same room or building or within the same enclosure, and connected either by direct physical connection or through a local area network (“LAN”). As used herein, “remote” is intended to convey the sense of being located in separate buildings, cities, towns or metropolitan areas, and connected via a bridging switch and a wide area network (“WAN”).

At the voice response node 35, there is acceptably a plurality of VRUs, depending on the amount of anticipated call traffic. In the IVR platform architecture of FIG. 1, the host computer 25 acceptably services a plurality of voice response nodes 35. The reporting system 30 and the billing system 28 may be located either in a separate administrative center or in the platform architecture. In alternate embodiments, these various components are acceptably positioned in various combinations of remote and local (proximate) locations without affecting the functionality of the PPLD system.

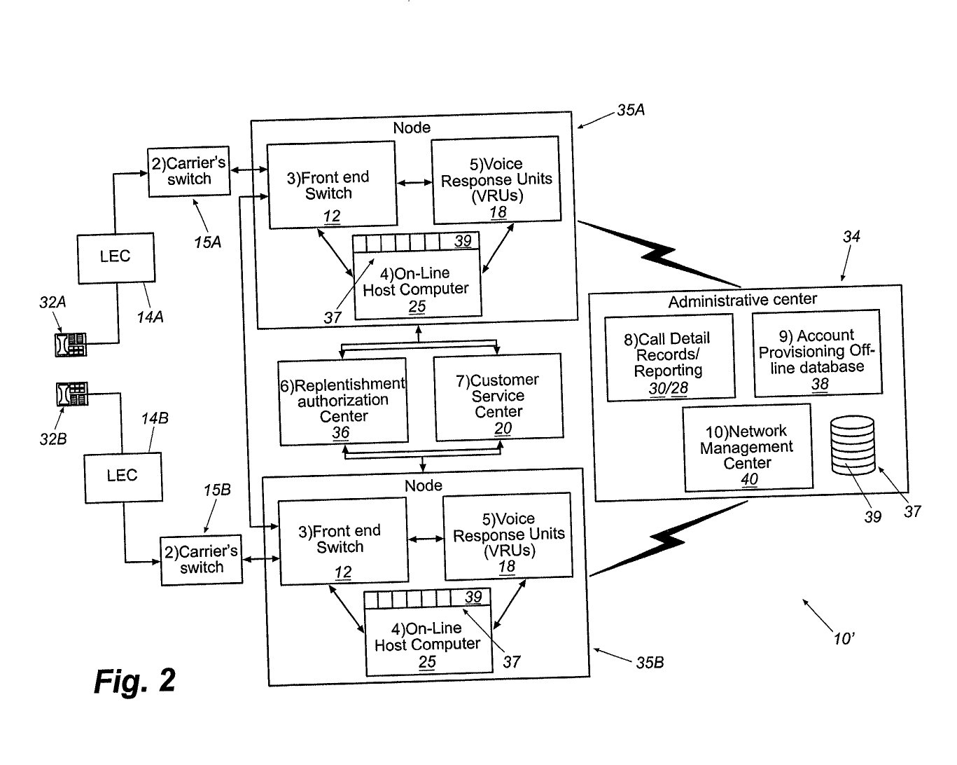

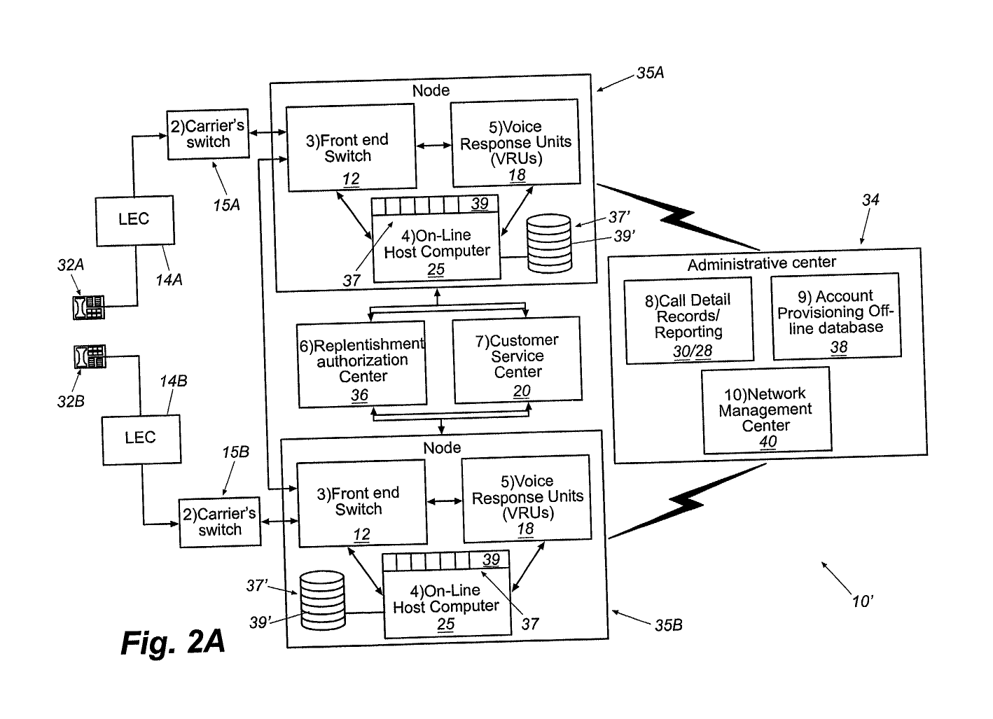

FIG. 2 depicts an alternate embodiment of the PPLD system 10′ showing additional elements and showing redundancy in the system architecture. In this alternate embodiment, user telephone 32A, 32B is connected through local exchange carrier (LEC) 14A, 14B to a carrier switch 15A, 15B. Each carrier switch 15A, 15B is redundantly connected to two voice response nodes 35A, 35B. The carrier switch 15 (e.g., 15A) routes telephone calls to one primary voice response node 35 (e.g., 35A), and when there is an overload or a failure with the primary voice response node 35 (e.g., 35A), then calls are routed to a secondary voice response node 35 (e.g., 35B). Each voice response node 35A, 35B comprises, in certain embodiments, a front-end switch 12 and a plurality of voice response units (VRUs) 18. Further, as shown in FIG. 2, a host computer 25 is associated with each voice response node 35A, 35B, and is positioned in local proximity to the respective VRU. Each voice response node 35A, 35B is also connected to a replenishment authorization center 36, a customer service center(s) 20, and an administrative center 34 where a reporting system 30, an account provisioning database 38, a network management center 40, and a memory storage device 37 for storing account records 39 are located. (Hereafter, unless made otherwise apparent from the context, a component number, e.g. switch 15, will be meant to refer generically to any one of the similar components in alternate embodiments, e.g. switch 15, 15A or 15B.) FIG. 2A depicts an example of alternate placement of storage devices 37′.

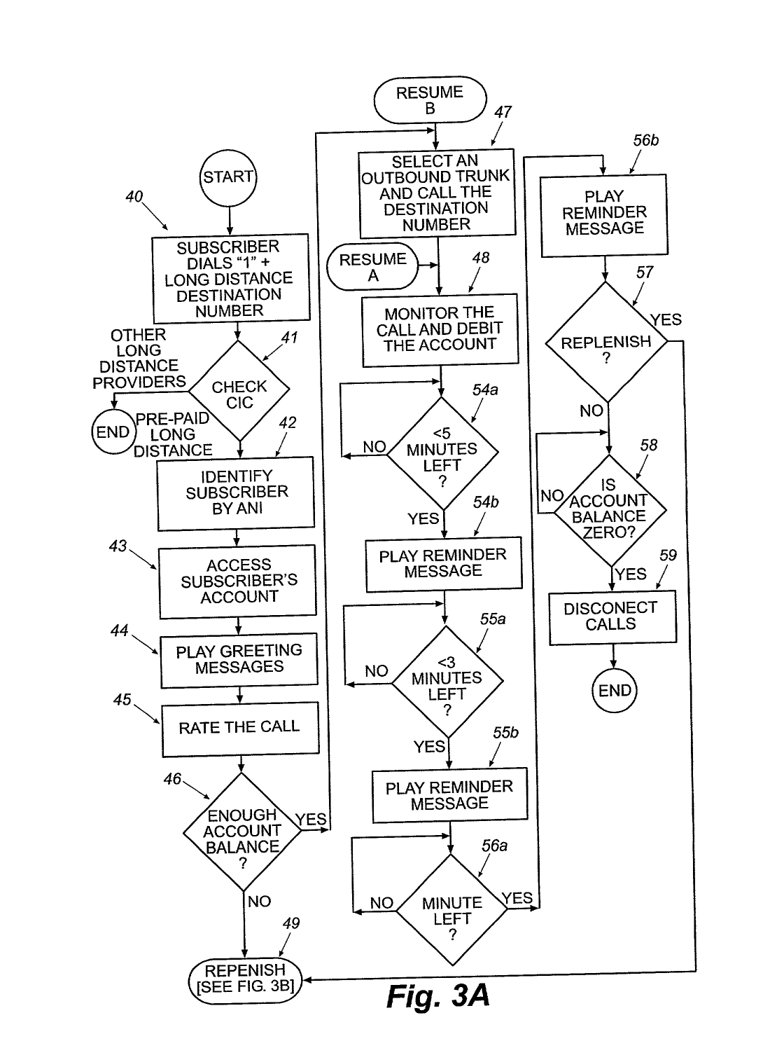

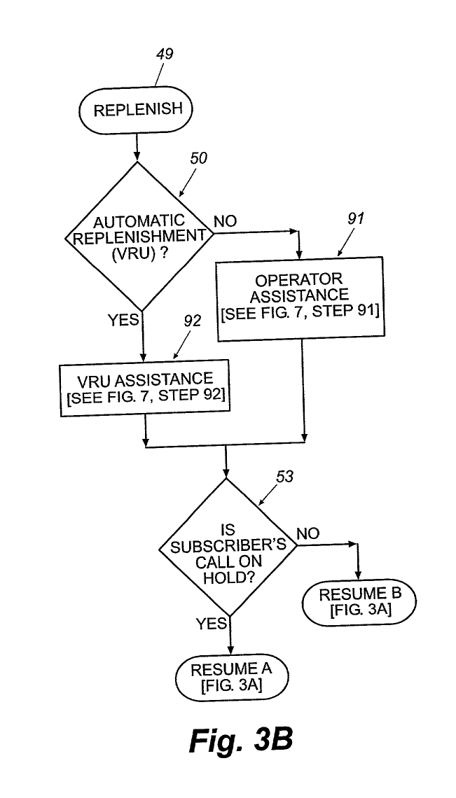

FIGS. 3A and 3B are exemplary flow charts of pre-paid call processing according to a one embodiment of the present invention. The pre-paid long distance telephone call service (the “PPLD” Service) starts with an end user dialing the appropriate (for his geographic region) numeric long distance indicator (for example, “1” or “011”) and a destination number, comprised of, for example, an area code and a seven-digit telephone number. This simple, direct dialing will ultimately result in the completion of a long distance telephone call and automatic payment from a prepaid account associated with the user's telephone. In accordance with an exemplary embodiment, upon subscription to the PPLD service, an “account” is created which is virtually represented as a data record (account) 39, or otherwise, as will be understood in the industry, in a memory storage 37 connected to or accessed by the host computer 25. The account 39 is preferably associated with the network address (for example, the telephone number) of the terminal/phone (or line) from which the user intends to place long distance calls (herein referred to as the customer's phone line, or subscriber's phone line). The PIC code of the subscriber's phone line is changed to the CIC code of the PPLD service IVR platform front-end switch 15. Preferably, the LEC 14 and the carrier switch 15 each maintain a database of associated ANI and CIC code such that each LEC and carrier switch is informed when a long distance call from the respective subscriber's phone line having respective ANI is associated with the CIC code of the PPLD service IVR platform front end switch 15.

Referring to FIGS. 3A and 3B, when a subscriber to the pre-paid long distance service dials a long distance telephone number (step 40), e.g., dials “1” or “011” followed by a destination number, the call is routed by a local exchange carrier (LEC) 14 (see FIG. 2) to a carrier switch 15. The carrier switch 15 checks the carrier CIC code (Step 41) and, when proper, routes the call to the front end switch 12 which is associated with an a voice response node 35 of the PPLD System 10. After the call is routed to the front-end switch 12, the front-end switch 12 identifies the subscriber's phone line (Step 42) by automatic number identification (ANI), and provides the information to the host computer 25. It is noted that, in accordance with alternate embodiments, the carrier switch 15 will provide one or both of ANI routing and/or CIC routing.

By way of example only, consider the following while referring to FIG. 2. For the purpose of this example, 5555 is the CIC of the front-end switches 12A, 12B associated with the PPLD system nodes 35A, 35B. LEC 14A and carrier switch 15A are each “loaded” to associate PPLD customer ANI's with 5555 CIC for transport. Calls received at LEC 14A from the respective customer line 32A are routed to the carrier switch 15A with the 5555 CIC and the ANI passed in the Carrier Identification Parameter (CIP) message stream from the LEC 14A. The carrier switch 15A identifies the 5555 CIC and routes the call to the PPLD system node 35A. To further the example, LEC 14B and carrier switch 15B are each “loaded” to associate the PPLD customer ANI with 5555 CIC for transport. However, in this example, LEC 14B does not or cannot pass the CIC code as part of the CIP message stream. Although not able to pass the CIC code, the LEC 14B knows the proper routing and routes the call to the carrier switch 15B with the ANI in the CIP message stream. The carrier switch 15B will then determine if the call should be routed to the IVR platform node 35B by performing an ANI lookup in the carrier switch's routing database. If appropriate, the carrier switch 15B will route the call to the node 35B with the 5555 CIC code passed and with the ANI in the CIP message stream. In each case, the node 35A does not have to do any other work in identifying the account 39 in the database 37 because the 5555 CIC together with the customer's ANI will be the distinguishing factors for identifying PPLD application and accounts. In other words, there are no other applications associated with the node 35A that share the 5555 CIC.

In any case, in this example, the IVR platform receives the CIC information at the front-end switch 12, transfers the data to the host 25, and the host looks up the calling ANI to validate the account information. In the case of, for example, 1+ calls, the IVR platform takes the calling ANI+CIC in the message stream to lookup the account in the host database.

The host computer contains appropriate software responsible for call processing, storing prepaid long distance accounts, and sending command and control messages to the various hardware components in the voice response node 35, which include the front end switch 12, VRUs 18, and other systems located in the administrative center 34. The host computer 25 checks for the individual account information (Step 43), selects a voice response unit (VRU) 18, and directs this VRU to play the appropriate greeting messages (Step 44). The greeting messages, as well as the minutes remaining message, the money balance message, and the thank you for using message, may be enabled or disabled, individually or collectively, by each user via the service menu options.

The host computer 25 then looks up the calling rate (Step 45) and determines (Step 46) whether there is a sufficient account balance to complete the call. In one embodiment of the invention, the customer service agent will also be able to provide on-line rate quoting to the user via the PPLD service software by simply depressing a function key. The host computer 25 is also responsible for recording call detail information such as, for example, the destination number and the call duration, which will be downloaded later to, for example, the reporting system 30 or a billing system 28. The call detail record (CDR) information is transmitted to the reporting system 30 (or billing system 28) at regular time intervals.

Furthermore, VRUs 18 provide other services to end-users. For example, end users can use VRUs 18 to change their preferred language while accessing the voice response node 35. They can also check a current balance, request an account statement to be sent to their account address, and replenish their account with, for example, credit cards. As soon as users reach the voice response node 35 and hear the welcome greeting, the VRU 18 instructs the user on how to place a call and, also, identifies what dual tone multi-frequency (DTMF) key to use to reach the service menu or a customer service representative. Changes made at the service menu are done in real-time and the change commands are sent to the host computer 25 for account updates.

Referring to the diagram at Step 46 FIG. 3A, if the host computer 25 determines that the account information is associated with a validly established pre-paid account and there is a sufficient account balance to complete a call, the host computer 25 instructs the front-end switch 12 to bridge the call (Step 46). In response, the front-end switch 12 (Step 47) selects an idle outbound trunk and places a call to the destination telephone number. The caller is then connected, for example, via a conference port in the front-end switch 12, to the destination number. The host computer 25 monitors the call and debits the subscriber's account accordingly (Step 48). The call monitoring and account debiting are on going activities until the call is disconnected. Periodically during the call, as represented by Steps 54a/b, 55a/b, 56a/b, an announcement of the available balance is provided to the caller. In exemplary embodiments, a warning message is provided (Step. 54b) to the caller by the VRU during the telephone call when, for example, at Step 54a the calculated time to depletion of the account 39 is five (5) minutes. Other warning messages are given when there are, for example, three (3) minutes remaining on the account (Steps 55a/b), and when there is, for example, one (1) minute remaining on the account (Steps 56a/b). As represented by Step 57, the VRU 18 interrupts the caller during or after a reminder period and asks if the caller wants to replenish his/her account to continue the conversation with the called party. The VRU 18 plays, for example, “You have X minutes remaining for this call. To replenish your account now, press 1. To continue with your conversation, press 2.”

In the stated example, if the end user presses “1”on their DTMF dial pad, the IVR platform (e.g., host and front end switch interaction) puts the called party on music or on hold, while the caller interacts with the IVR platform, and proceeds into the replenishment menu. The called party's line remains open, but the host is given a memory command to remember the caller's and the called's port numbers in order to reconference the parties appropriately after the replenishment event. The called party is, for example, given intercept, “Please continue to hold,” messages set at certain intervals.

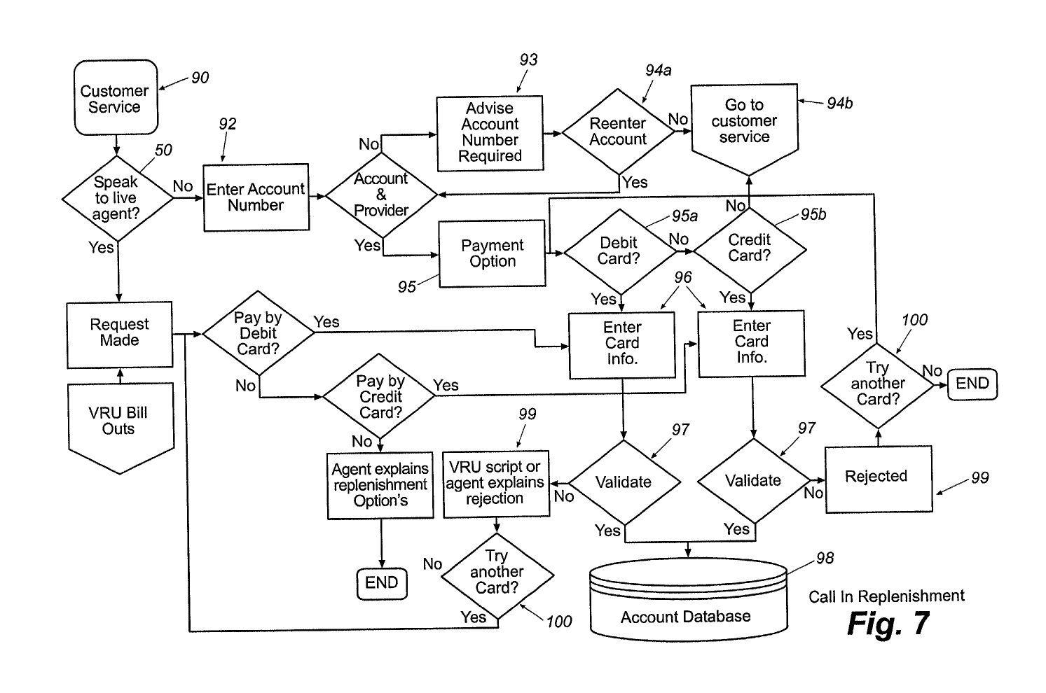

Meanwhile, the DTMF entry of “1” would, in the stated example, indicate to the host computer 25 that the caller should be placed back in the call flow (Step 49)(FIG. 3B and FIG. 7) where the caller has the option (Step 50) of being connected to a VRU (Step 92) or a customer service representative (Step 91) to replenish the account. The caller is then put on hold while bridged to the IVR platform. In the background, the host is, for example, sending a TCP/IP real time transaction to the credit/debit/bank/check card authorization vendor, connected to the host 25 via a frame relay or X.25 gateway protocol, for approval. Upon receipt of an approval or decline message from the authorization vendor, the host relays the message to the caller via VRU's scripts If the transaction is approved, the host 25 adds a new balance to the caller's account 39 and the caller is bridged back to the called party (step 53). If the transaction is declined, the caller is bridged back to the called party for an amount of time which corresonds to the time supported by his/her account balance (Step 53). Neither the caller nor the called party is charged any balance off the account during the replenishment event.

If the caller does not choose to replenish the account (e.g., presses “2”), the call will be dropped when the balance of the account reaches zero (Steps 58, 59), or, more typically, when the remaining balance in the account is insufficient to cover another time-increment of monitored-time. In exemplary embodiments, for example, the time-increment of monitored-time is one-minute increments. Thus, the PPLD system 10 looks ahead and anticipates the time incremental charges and, in certain embodiments, prevents the call from overcharging the account. In embodiments involving the auto-replenishment with threshold payment feature described herein, the caller's account is allowed to go below “zero”, and, once the call is completed, the PPLD system will replenish the account in accordance with the auto-replenishment process. After the call is completed, the cost of the call is debited from the subscriber's account and updated information about the account balance is updated for VRU 18.

Referring back to Step 46, if there is not a sufficient balance to initially complete the call, the caller is given the option (at Step 49) to reach a VRU or a customer service representative to replenish the account. With reference to FIG. 3B, the caller chooses either to reach an operator or to use automated VRU assistance by entering DTMF digits (at Step 50). If the subscriber chooses the operator assistance (Step 51), then the host computer 25 uses its resident automatic call detail (ACD) software. The ACD software of the host computer 25 maintains an internal table of all of the available customer service representative positions including language support information and related direct inward dialing (DID) numbers. The ACD selects a customer service representative position based on the language necessary to handle the caller, the type of call, and whether or not the ACD already has a call up on the position. The front-end switch 12 uses a conference port to connect the caller to the selected customer service representative located at the Customer Service Center 20.

The customer representative (referred to herein interchangeably as the operator) at operator service center 20 may perform actions on behalf of the subscriber (such as provide automated rating information, perform a replenishment transaction, or look up country code information). While these actions are being taken, the subscriber remains bridged with the Customer service representative's DID line via the voice response node 35. After the representative performs said action, the representative gives the end user the option of terminating the service call, returning to the voice response node's main menu (which gives instructions on how to place an outbound destination call), or completing an outbound destination call. After a service call is terminated (either by release into the voice response node 35 or by Customer Service call completion transactions), the Customer Service leg of the voice call is released immediately and made available for the next service call. Meanwhile, the end-user is either returned to the voice response node 35, or connected to the destination party via the carrier switches 15.

If the subscriber chooses to replenish the account using automated VRU assistance (Step 52), the subscriber is asked by the VRU to enter credit card (or other financing) information and charge amount information over the telephone by using DTMF keys. Once the information is received, the host computer 25 sends a real-time charge request to a credit or financing authorization center 36 (such as, by way of example only, the National Data Corporation). The subscriber may hear music or silence while the request is launched to the replenishment authorization center 36. The transaction is either approved or declined and the subscriber is placed back into the main menu of the voice response node 35. After replenishing the account, the call processing is resumed (see Step 53) at either “Resume A” or “Resume B”, depending on whether or not the subscriber was connected previously and has placed the call on hold.

Once a destination party is bridged to the end user, the voice response node 35 remains bridged on the call to ensure proper account debiting and Call Detail Record (CDR) creation. As calls are processed through the voice response node 35, the host computer 25 records call detail information, which is later downloaded to the Administrative Center 37, billing system 28 and reporting system 30 via a data link. In at least one embodiment, the Administrative Center 34 downloads CDR information periodically, such as, for example, every thirty minutes. The Administrative Center 34 also stores subscriber account information and provisioning information 38, such as, for example, name, address, account-associated telephone number, etc. The Administrative Center 34 also has a Network Management Center 40 that monitors performance and tracks network trouble.

In other alternate embodiments, multiple residences or multiple persons have access to the same phone line, and each residence/person has its own pre-paid account. For example, the PPLD system can provide for multiple sub-accounts to be used under one primary account, each sub-account having its own unique pre-paid account balance. In such an embodiment, each sub-account (or “instance of the primary account”) has a unique PIN or security code. After dialing a destination number, the caller is prompted for a PIN that the caller must enter before the proper account information is accessed. Upon entering the PIN, the mainframe host computer 25 will identify the account (or sub-account), check the available balance, provide the balance information to the caller, and complete the call if there are sufficient finds.

When a customer signs up for the pre-paid service, she can choose the language preference for prompts and for customer service. She can also choose a method for account replenishment. The replenishment of the account can be accomplished in several ways including direct payment, payment via the internet, payment at retail locations, payment made by calling in and by recurring payment. Payments can be made by cash, check, credit card, or debit/bank/check card, or other acceptable process of financing the intended amount.

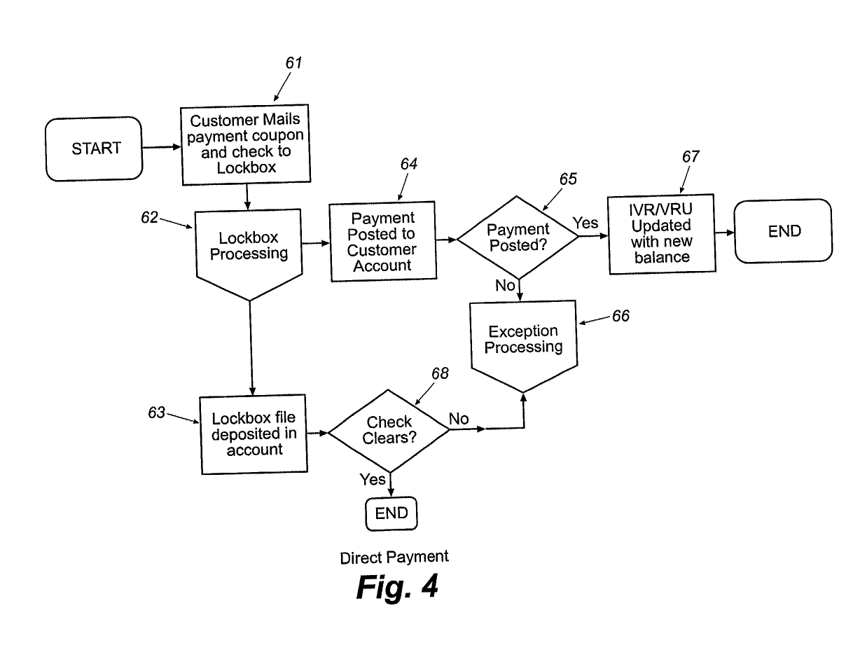

The subscriber/customer can replenish her account by mailing the payment directly as illustrated in FIG. 4. The process is as follows. (Note that in the following descriptions the reference numerals refer to acts described in specific logic blocks or decision blocks in the accompanying drawings.) The customer elects to replenish by check and mails payment coupon and check to a lockbox location (step 61). At the lockbox processing location (step 62), the check is deposited in a service provider account (step 63), and the payment is posted to the customer account (step 64). If the payment is not posted (step 65) or the check is not cleared (step 68), then the account is referred to exception processing (step 66). If payment is posted properly, then the account balance is updated (step 67) and reflected by the next VRU 18 announcement to the customer.

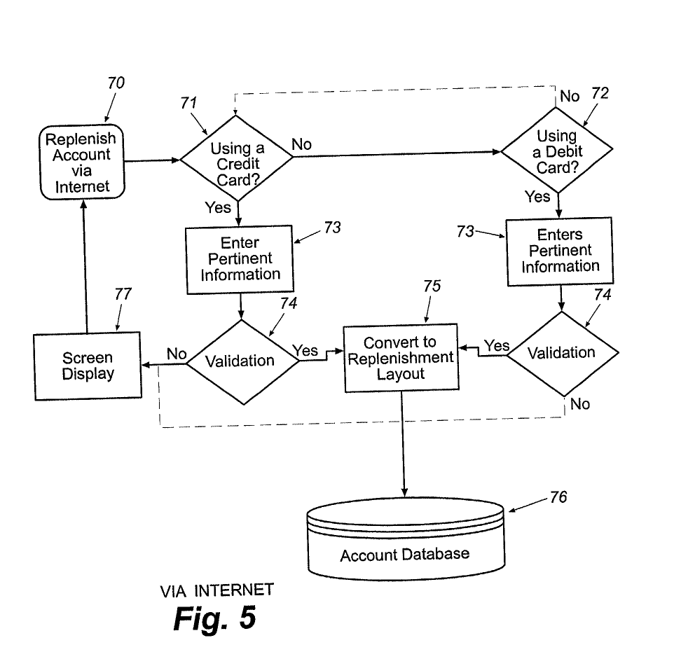

The customer can also replenish her account via the Internet as illustrated in FIG. 5. The customer accesses the service provider's web site (step 70) and is provided with the options of replenishing the account with a credit card (step 71) or a debit card (step 72). After entering pertinent information (step 73) for the chosen card, such as the replenishment amount, the PIN number, card type, expiration date, and billing information, the information and the transaction are processed for validation (step 74). If they are validated, the information is then converted to the accounting format (step 75) and sent to the account database to update the balance (step 76). If the information and transaction are not validated, a message screen will be displayed to the customer (step 77), and the customer can choose to restart the replenishment process.

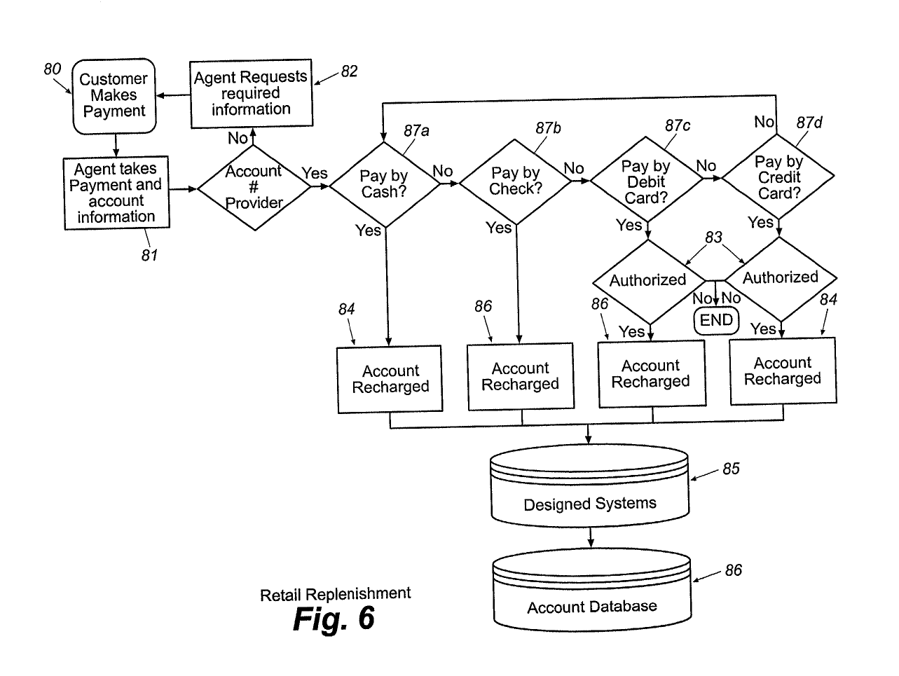

FIG. 6 illustrates the process to replenish an account at retail locations. The customer requests payment at an authorized payment center (step 80), and the authorized agent accepts the payment and asks for the account information (step 81) such as the account number. The payment is not accepted without the accompanying account information (step 82). If the payment is made by cash or by check (Step 87a and 87b) that has been previously validated by a service bureau or similar services, it will be accepted immediately. If it is made with a credit card or a debit/bank/check card (87c and 87d) or other form of financing, then transaction must be authorized and validated (step 83). After the payment is accepted, the agent makes an entry for recharging the account (step 84). The PPLD system then returns a message, preferably an ASCII message, indicating the balance remaining. This message's return will allow the agent to print a receipt which indicates how much time was purchased on the account and the ending balance after the replenishment transaction. The transactions at these authorized payment centers are funneled through designated systems (step 85) (such as, by way of example, CashPoint) through the terminal server and host computer before reaching the account database (step 86), where the account in the database is updated accordingly.

The customer also has the option of replenishing the account by calling customer service representatives as illustrated in FIG. 7. The customer can reach customer service representatives by calling a customer service line (Step 90) which provides the option (at step 50) to replenish the account through an automated service or through an on line agent. If the customer chooses to use the automated approach, the voice response unit (VRU) will prompt for the account number (step 92). If the account number is not provided properly, the VRU will request that the number be entered again (Step 93). If the customer fails to key in the account number properly on the second try (Step 94a), the call is directed to a customer service representative (Step 94b).

After the account number is properly entered into the system, the VRU 18 will prompt the user for the payment option (Step 95). The payment is accepted, for example, via either a credit card (Step 95b) or a debit/bank/check card (Step 95a). If the customer fails (in this example embodiment) to select one of these options, she is connected to a customer service representative for assistance (step 94b). After selecting either a credit card or a debit/bank/check card (or, acceptably, some other form of financing) and providing the card number (or financing information) to the automated computer system (step 96), the system computer will validate the transaction (step 97). If the transaction is validated, the information is sent to the account database and the balance is updated (step 98). If the transaction fails to be validated, the VRU will provide a message explaining the rejection (step 99), and the customer can choose to use another financing option (for example, another card) (step 100) or speak to a customer service representative.

If the customer chooses to transact through a customer service representative, she is then connected to an available customer service representative (step 91). The customer service representative asks for the account information, if the customer is calling from a telephone other than the subscribed telephone, and the payment method. If the customer selects, for example, either a credit card or a debit/bank/check card, the customer service representative enters the card information into the automated computer system at step 96 and starts the validation process (step 97). If the customer does not use a financing option acceptable to the system, the customer service representative will not be able to assist her, and the session will be terminated. If the transaction is validated, then the information is sent to the account database and the balance updated (step 98). If the transaction validation failed, the customer service representative will provide an explanation to the customer (step 99), and the customer will have the option of trying with a different card (step 100).

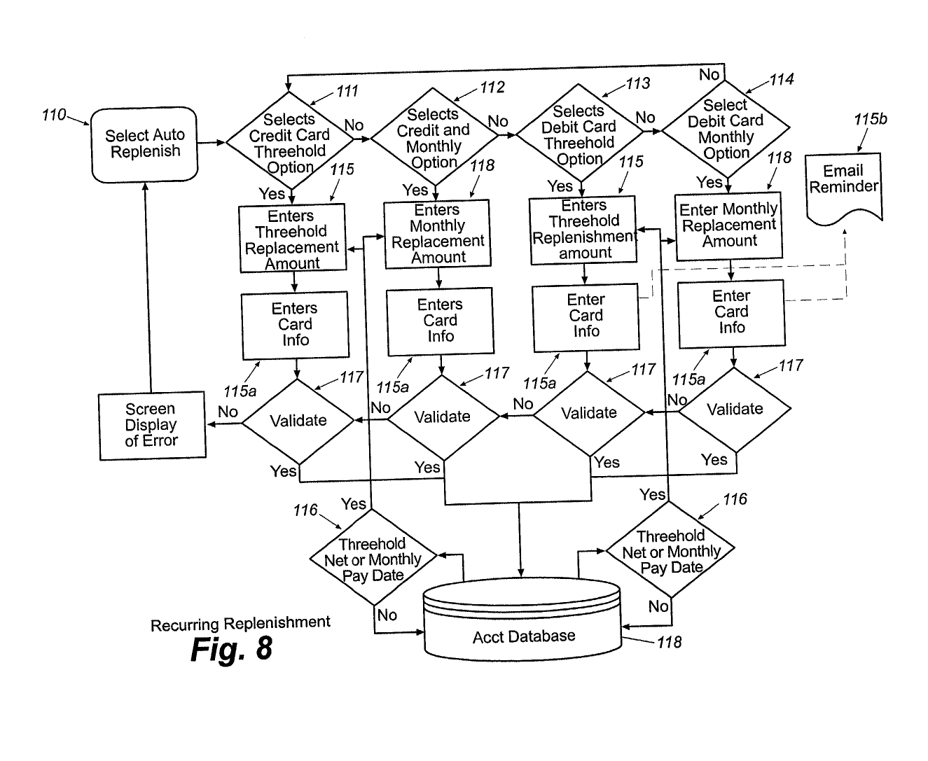

The customer can avoid the monthly ritual of account replenishment by selecting the automatic recurring replenishment option, when she signs up for the pre-paid long distance telephone service as illustrated in FIG. 8. The customer is given the option of automatic replenishment when signing up for the pre-paid long distance telephone service (step 110). An indication of the customer's selection of the automatic replenishment option will be transmitted to the PPLD System as part of the provisioning information. The user will hear a one-time message upon first entry into the platform, giving them instructions on how to set up her auto replenishment profile. Once the profile is set up, the authorization service provider for credit card processing (or other financing processing) confirms that the proffered form of financing (for example, the credit card) is valid and the user will be eligible immediately to have this feature applied to her account.

In accordance with one example of the automatic replenishment option, the customer can select credit card with threshold payment (step 111), credit card with monthly payment (step 112), debit card with threshold payment (step 113), or debit card with monthly payment (step 114). (Other forms of financing are, also, acceptable.) If an option with threshold payment is selected, the customer is prompted to enter the threshold replenishment amount for the account (step 115) and pertinent card information (115a), such as the card type, expiration date, PIN, billing information, and e-mail address. In an exemplary embodiment, the user may set a minimum replenishment amount (or “addition”) (for example, of ten ($10.00) dollars), such replenishment additions to occur when the account depletes to a balance threshold (for example, five ($5.00) dollars) or less. This minimum addition may be altered. A maximum amount the user's automatic replenishment account will hold can be set by the system administrator (or by system constraints), for example, at nine hundred ninety nine ($999.00) dollars. Whenever the account balance reaches the threshold level for activation of the replenishment feature (step 116), the system automatically enters the replenishment amount and validates the transaction (step 117). The account balance (118) is updated after the validation is successfully completed. If validation fails, the user is notified by e-mail, U.S. mail, or VRU message (step 120). Additionally, an e-mail reminder is sent reminding the debit card customer to authorize an upcoming debit by entering his or her PIN (115b).

If the customer selects an option with monthly payment provisions, the customer will enter the monthly replenishment amount for the account (step 118) when the account is first established. By way of example, the customer can select to have Y dollars added to the account on day X of the month, but not to exceed a preset total maximum balance (for example, of nine hundred ninety-nine ($999.00) dollars). The system will establish a minimum monthly addition to the account, such as ten ($10.00) dollars. The user may change this monthly replenishment amount periodically after the initial set-up. On the replenishment date of each month (step 116), the system automatically enters the replenishment amount and validates the transaction (step 117). (The replenishment procedure of these monthly payment options is not triggered by balance; thus, if the balance falls below a certain amount prior to the replenishment date, the automatic replenishment will still not occur until the replenishment date.) The account balance will be updated after the validation is successfully completed. If validation fails, the user is notified by e-mail, U.S. mail, or VRU message.

The implementation of the present invention in the herein described embodiments has been described as a computer program that can be resident on one or more devices such as, without limitation, front-end switches, voice response units or main frame computers. It is important to note, however, that those skilled in the art will appreciate that the implementations of the present invention are capable of being distributed as a program product in a variety of forms, and that the present invention applies equally regardless of the particular type of signal bearing media being utilized to actually carry out the distribution. Examples of signal bearing media include, without limitation, recordable type media such as cassettes or CD ROMs and transmission type media such as analog or digital communication links.

Although the present invention has been described with reference to certain embodiments thereof, numerous variations, additions, modifications and substitutions also can be made to the present invention. Therefore, the spirit and scope of the appended claims is not limited by the description of the versions contained herein.

What is claimed is:

1. A method for providing a long distance telephone service to a customer placing a long distance telephone call from a telephone, said method comprising the steps of:
establishing a pre-paid customer account in a customer account database;
assigning a carrier identification code to a customer telephone line;
dialing a long distance telephone call on the telephone associated with said telephone line;
checking said account database associated with said telephone line for availability of funds to complete the long distance telephone call; and
enabling the long distance telephone call, if there are sufficient funds in said customer account database.

2. The method for providing a long distance telephone service of claim 1 further comprising the step of providing customer account balance information to the customer before enabling the long distance telephone call.

3. The method for providing a long distance telephone service of claim 1 further comprising the steps of setting up an account database on a server; and receiving advance payment from a customer.

4. The method for providing a long distance telephone service of claim 1, wherein the step of assigning further comprises the step of replacing a primary exchange carrier code of said telephone line with said carrier identification code.

5. The method for providing a long distance telephone service of claim 1, wherein the step of checking further comprises the step of calculating available time based on a destination location and a calling rate to said destination location.

6. The method of providing a long distance telephone service of claim 1, wherein the step of enabling further comprises the step of routing said call through a public telephone network to said destination location.

7. The method of providing a long distance telephone service of claim 1, further comprising the step of deducting the cost of the long distance telephone call from the customer account until the long distance telephone call is terminated.

8. A method of placing long distance telephone calls comprising the steps of:
establishing a pre-paid customer account associated with a user telephone;
placing a telephone call directly from the user telephone; and,
replenishing said pre-paid account with additional funding.

9. The method of placing long distance telephone calls of claim 8, wherein said step of replenishing further comprises the step of establishing an automatic replenishment protocol.

10. The method of placing long distance telephone calls of claim 8, wherein said step of replenishing further comprises the step of providing a credit card number to a customer service representative.

11. The method of placing long distance telephone calls of claim 8, wherein said step of replenishing further comprises the step of providing a debit/bank/check card number to a customer service representative.

12. The method of placing long distance telephone calls of claim 8, wherein said step of replenishing further comprises the step of mailing a check or a money order to a customer service center for crediting to an account.

13. The method of claim 8, further comprising the step of deducting the cost of the telephone call from the prepaid account.

14. A system for providing long distance telephone call service to telephone customers, comprising:
an account database residing at a server; and
an interface capable of making inquiries to the account database for the availability of funds associated with a customer telephone line.

15. A system for providing prepaid long distance telephone call services, comprising:
a front-end switch;
a plurality of voice response units connected to said front-end switch;
a data network connected to said front-end switch;
at least one operator service center connected to said data network;
a billing module connected to said data network;
a reporting module connected to said data network; and
a host computer connected to said data network, said host computer having access to a pre-paid account database.
